(19) United States
(12) Patent Application Publication
(10) Pub. No.: US 2023/0210159 A1
(43) Pub. Date: Jul. 6, 2023

(54) Flavor Delivery Device

(71) Applicant: Ava Jackson, Topeka, KS (US)

(72) Inventor: Ava Jackson, Topeka, KS (US)

(21) Appl. No.: 17/568,874

(22) Filed: Jan. 5, 2022

(51) Int. Cl. A23P 10/10; A23L 27/00

(52) U.S. Cl. CPC A23P 10/10; A23L 27/88

(57) ABSTRACT

A flavor delivery device for delivery of a flavoring agent to an oral cavity of a user includes a swab and a flavoring agent. A stick of the swab has a pad engaged thereto proximate to a first end thereof. A flavoring agent, which is intended to satisfy a taste craving, is engaged to the pad and is released from the pad when the pad is moisturized, such as by wetting with water or saliva. The stick can be grasped in a hand of a user to position the pad to be moistened and into an oral cavity, either their own or that of a person requiring assistance. The flavoring agent is released from the pad into the oral cavity to alleviate the taste craving.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to delivery devices and more particularly pertains to a new delivery device for delivery of a flavoring agent to an oral cavity of a user.

### (2) Description of Related Art Including Information Disclosed Under 37 CFR 1.97 and 1.98

The prior art relates to delivery devices, and more particularly to delivery devices for delivery of a flavoring agent to an oral cavity of a user. Prior art delivery devices may comprise gums, lozenges, edible strips, and sprays.

### BRIEF SUMMARY OF THE INVENTION

An embodiment of the disclosure meets the needs presented above by generally comprising a swab, which comprises a stick that has a pad engaged thereto proximate to a first end thereof. A flavoring agent, which is intended to satisfy a taste craving, is engaged to the pad and is configured to be released from the pad when the pad is moisturized, such as by wetting with water or saliva. The stick is configured to be grasped in a hand of a user. The user is positioned to moisten the pad and to position the pad in an oral cavity, either their own or that of a person requiring assistance. The flavoring agent is released from the pad into the oral cavity to alleviate the taste craving.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a flavor delivery device according to an embodiment of the disclosure.

FIG. 2 is a cross-sectional view of an embodiment of the disclosure.

FIG. 3 is an isometric perspective view of an embodiment of the disclosure.

FIG. 4 is a cross-sectional view of an embodiment of the disclosure.

### DETAILED DESCRIPTION OF THE INVENTION

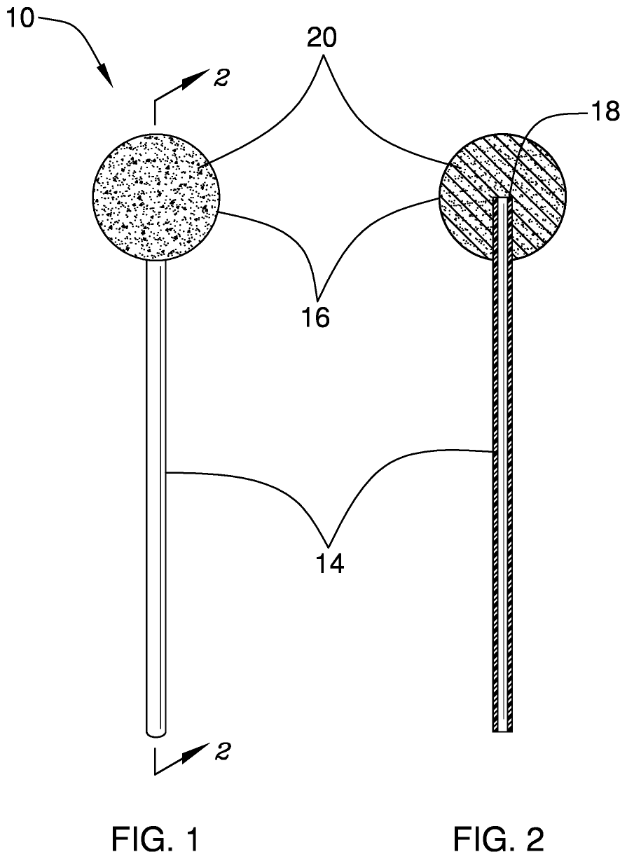

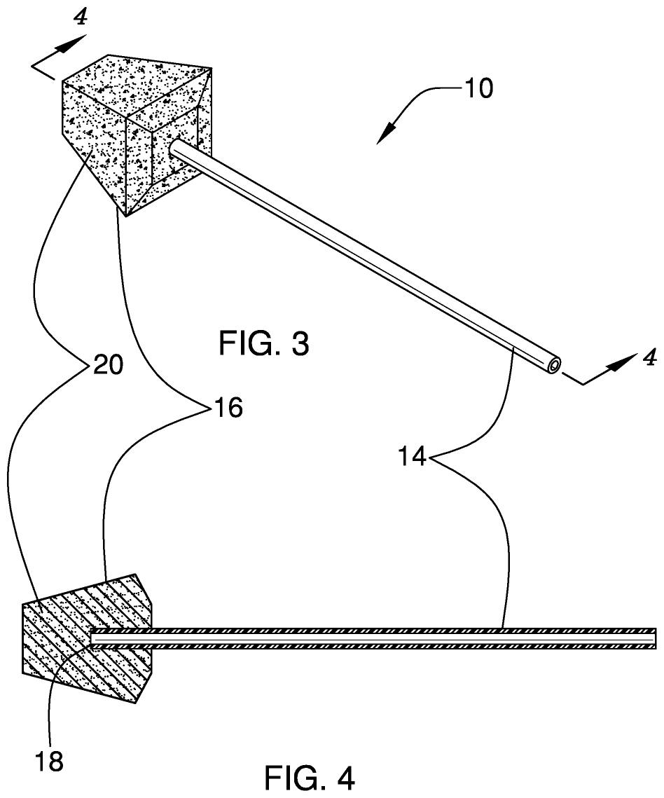

With reference now to the drawings, and in particular to FIGS. 1 through 4 thereof, a new delivery device embodying the principles and concepts of an embodiment of the disclosure and generally designated by the reference numeral 10 will be described.

As best illustrated in FIGS. 1 through 4, the flavor delivery device 10 generally comprises a swab 12, which comprises a stick 14 that has a pad 16 engaged thereto proximate to a first end 18 thereof. The pad 16 may be spherically shaped, square pyramidal frustum shaped, or other shape, such as cubical, ovoid, and the like. The pad 16 comprises at least one of natural sponge, polyester sponge, vegetal cellulose sponge, cotton, and rayon.

The stick 14 may be tubular or solid and comprises at least one of plastic, wood, bamboo, and rolled paper.

The flavoring agent 20, which is intended to satisfy a taste craving, is engaged to the pad 16 and is configured to be released from the pad 16 when the pad 16 is moisturized, such as by wetting with water or saliva. The stick 14 is configured to be grasped in a hand of a user. The user is positioned to moisten the pad 16 and to position the pad 16 in an oral cavity, either their own or that of a person requiring assistance. The flavoring agent 20 is released from the pad 16 into the oral cavity to alleviate the taste craving. The device 10 is anticipated to be useful in meeting the needs of individuals who cannot consume solid food, but who still wish to enjoy their favorite tastes, and individuals who want a calorie free snack.

The flavoring agent 20 may comprise a cheeseburger flavor, a barbecued rib flavor, a bacon flavor, a spaghetti flavor, a meatloaf flavor, a rotisserie chicken flavor, a macaroni and cheese flavor, a carrot flavor, a green bean flavor, a potato flavor, an apple pie flavor, a mango flavor, an orange flavor, a coffee flavor, a caramel latte flavor, a lemon aid flavor, a buttered popcorn flavor, a cinnamon flavor, a cotton candy flavor, a pina colada flavor, and a strawberry margarita flavor. As will be apparent to one skilled in the art of flavoring agent 20s, there is a large selection of flavoring agents 20 that might be engaged to the pad 16, and these are anticipated by the present invention.

In use, the pad 16 is positioned in the oral cavity, with or without prior moistening, and can be motivated across the gums, checks, and tongue so that the flavoring agent 20 releases from the pad 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A flavor delivery device comprising:
a swab comprising a stick having a pad engaged thereto proximate to a first end thereof; and
a flavoring agent engaged to the pad and being configured for being released from the pad upon the pad being moisturized, wherein the stick is configured for grasping in a hand of a user, positioning the user for moistening the pad and for positioning the pad in an oral cavity, such that the flavoring agent is released from the pad into the oral cavity.

2. The flavor delivery device of claim 1, wherein the pad is at least one of spherically shaped and square pyramidal frustum shaped.

3. The flavor delivery device of claim 1, wherein the pad comprises at least one of natural sponge, polyester sponge, vegetal cellulose sponge, cotton, and rayon.

4. The flavor delivery device of claim 1, wherein the stick is tubular.

5. The flavor delivery device of claim 1, wherein the stick comprises at least one of plastic, wood, bamboo, and rolled paper.

6. The flavor delivery device of claim 1, wherein the flavoring agent comprises at least one of a cheeseburger flavor, a barbecued rib flavor, a bacon flavor, a spaghetti flavor, a meatloaf flavor, a rotisserie chicken flavor, a macaroni and cheese flavor, a carrot flavor, a green bean flavor, a potato flavor, an apple pie flavor, a mango flavor, an orange flavor, a coffee flavor, a caramel latte flavor, a lemon aid flavor, a buttered popcorn flavor, a cinnamon flavor, a cotton candy flavor, a pina colada flavor, and a strawberry margarita flavor.

7. A flavor delivery device comprising:
a swab comprising a stick having a pad engaged thereto proximate to a first end thereof, the pad being at least one of spherically shaped and square pyramidal frustum shaped, the pad comprising at least one of natural sponge, polyester sponge, vegetal cellulose sponge, cotton, and rayon, the stick being tubular, the stick comprising at least one of plastic, wood, bamboo, and rolled paper; and
a flavoring agent engaged to the pad and being configured for being released from the pad upon the pad being moisturized, wherein the stick is configured for grasping in a hand of a user, positioning the user for moistening the pad and for positioning the pad in an oral cavity, such that the flavoring agent is released from the pad into the oral cavity, the flavoring agent comprising at least one of a cheeseburger flavor, a barbecued rib flavor, a bacon flavor, a spaghetti flavor, a meatloaf flavor, a rotisserie chicken flavor, a macaroni and cheese flavor, a carrot flavor, a green bean flavor, a potato flavor, an apple pie flavor, a mango flavor, an orange flavor, a coffee flavor, a caramel latte flavor, a lemon aid flavor, a buttered popcorn flavor, a cinnamon flavor, a cotton candy flavor, a pina colada flavor, and a strawberry margarita flavor.
